(19) United States
(12) Patent Application Publication
(10) Pub. No.: US 2024/0193728 A1
(43) Pub. Date: Jun. 13, 2024

(54) METHOD AND ELECTRONIC DEVICE FOR TRAINING IMAGE PROCESSING MODEL AND METHOD AND ELECTRONIC DEVICE FOR PROCESSING IMAGES USING IMAGE PROCESSING MODEL

(71) Applicant: SAMSUNG ELECTRONICS CO., LTD., Suwon-si (KR)

(72) Inventors: Chao ZHANG, Beijing (CN); Qiang WANG, Beijing (CN); Jingu HEO, Suwon-si (KR); Dong Kyung NAM, Suwon-si (KR); Yasi WANG, Beijing (CN)

(73) Assignee: SAMSUNG ELECTRONICS CO., LTD., Suwon-si (KR)

(21) Appl. No.: 18/532,570

(22) Filed: Dec. 7, 2023

(30) Foreign Application Priority Data
Dec. 7, 2022 (CN) 202211567770.5
Aug. 23, 2023 (KR) 10-2023-0110801

(51) Int. Cl. G06T 3/4053; G06T 7/20; G06V 10/24; G06V 10/44; G06V 10/80

(52) U.S. Cl. CPC G06T 3/4053; G06T 7/20; G06V 10/245; G06V 10/44; G06V 10/806

(57) ABSTRACT

Provided is an image processing method of an image processing model, the image processing method including obtaining an input image group, the input image group including a plurality of low-resolution images corresponding to a plurality of different viewpoints, respectively, obtaining a feature of low-resolution images by extracting a feature for each low-resolution image of the plurality of low-resolution images included in the input image group, obtaining a fusion residual feature by fusing the feature of low-resolution images, and obtaining a super-resolution image corresponding to the input image group based on the fusion residual feature.

### CROSS-REFERENCE TO RELATED APPLICATIONS

This application claims priority to Chinese Patent Application No. 202211567770.5, filed on Dec. 7, 2022, in the China National Intellectual Property Administration, and Korean Patent Application No. 10-2023-0110801, filed on Aug. 23, 2023, in the Korean Intellectual Property Office, the disclosures of which are incorporated by reference herein in their entireties.

### BACKGROUND

### 1. Field

Embodiments of the present disclosure relate to image processing, and more particularly, to a method and apparatus for processing images and a method and apparatus for training an image processing model.

### 2. Description of Related Art

Image super-resolution technology aims to reconstruct one or more low-resolution images into high-resolution images. While single-image super-resolution typically increases high-frequency detail by learning a prior image, multi-image super-resolution provides the possibility of reconstructing richer detail by combining image information from different viewpoints.

In related technologies, multi-image super-resolution technology aims for video super-resolution or (high-speed) continuous shooting super-resolution. Optical flow is used to align different low-resolution inputs, and different low-resolution images are directly fused to obtain a super-resolution image. In this case, direct fusion makes it difficult to effectively utilize information of multiple images, and as a result, some details of the image may be lost, and accordingly, super-resolution performance also deteriorates.

### SUMMARY

One or more embodiments may address at least the above problems and/or disadvantages and other disadvantages not described above. Also, the embodiments are not required to overcome the disadvantages described above, and an embodiment may not overcome any of the problems described above.

Embodiments of the present disclosure may provide a method and apparatus for processing images that may enhance an image processing effect and a method and apparatus for training an image processing model.

According to an aspect of an embodiment, there is provided an image processing method of an image processing model, the image processing method including obtaining an input image group including a plurality of low-resolution images corresponding to a plurality of different viewpoints, obtaining a feature of low-resolution images by extracting a feature for each low-resolution image of the plurality of low-resolution images of the input image group, obtaining a fusion residual feature by fusing the feature of the low-resolution images, and obtaining, based on the fusion residual feature, a super-resolution image corresponding to the input image group.

The obtaining the fusion residual feature by fusing the feature of the low-resolution images may include obtaining an alignment feature of the low-resolution images by aligning the feature of the low-resolution images, and obtaining the fusion residual feature by fusing the alignment feature of low-resolution images through an attention-based residual feature fusion network of the image processing model.

The obtaining the fusion residual feature by fusing the alignment feature of the low-resolution images may include obtaining a fusion weight of each low-resolution image of the plurality of low-resolution images based on the alignment feature of the low-resolution images, and obtaining the fusion residual feature by obtaining a weight for the alignment feature of low-resolution images based on the fusion weight of the low-resolution images.

The obtaining the alignment feature of the low-resolution images by aligning the feature of the low-resolution images may include obtaining an optical flow of the input image group, and obtaining the alignment feature of the low-resolution images by aligning the feature of the low-resolution images based on the optical flow.

The optical flow may be a pre-obtained optical flow.

The extracting the feature for each of the plurality of low-resolution images of the input image group may include extracting a feature for each low-resolution image of the plurality of low-resolution images of the input image group through a heterogeneous convolution kernel of a feature extraction network of the image processing model.

The plurality of low-resolution images corresponding to the plurality of different viewpoints of the input image group may be a plurality of raw format images corresponding to a plurality of different viewpoints obtained simultaneously.

The obtaining the super-resolution image corresponding to the input image group based on the fusion residual feature may include obtaining a reconstruction feature by reconstructing the fusion residual feature a feature reconstruction network of the image processing model, and obtaining the super-resolution image corresponding to the input image group by refining the reconstruction feature through a feature refinement network of the image processing model.

According to another aspect of an example embodiment, there is provided a training method of an image processing model, the training method including obtaining a first training sample that includes a training image and a first training label corresponding to the training image, the training image including a low-resolution image and the first training label corresponding to a first high-resolution image of a corresponding training image, obtaining a first model by training an initial model based on the first training sample, obtaining information corresponding to transfer learning of the first model, obtaining a second training sample including a training image group and a second training label corresponding to the training image group, the training image group including a plurality of low-resolution images corresponding to a plurality of different viewpoints of a same scene, respectively, and the second training label corresponding to a second high-resolution image of a corresponding training image group, and obtaining an image processing model by training a second model based on the second training sample, the second model being configured based on the information corresponding to transfer learning of the first model.

The obtaining the first model by training the initial model based on the first training sample may further include obtaining a first high-resolution prediction image by inputting the training image to the initial model, obtaining a first prediction loss of the initial model based on the first high-resolution prediction image and the first training label, and obtaining the first model by adjusting a parameter of the initial model based on the first prediction loss.

The obtaining the first high-resolution prediction image by inputting the training image to the initial model may further include obtaining a feature of the training image by extracting a feature from the training image based on a feature extraction network of the initial model, and obtaining the first high-resolution prediction image based on the feature of the training image.

The obtaining the image processing model by training the second model based on the second training sample may further include obtaining a second high-resolution prediction image by inputting the training image group to the second model, obtaining a second prediction loss of the second model based on the second high-resolution prediction image and the second training label, and obtaining the image processing model by adjusting a parameter of the second model based on the second prediction loss.

The obtaining the second high-resolution prediction image by inputting the training image group to the second model may further include obtaining a feature of each image by extracting a feature for each image of the training image group based on a feature extraction network of the second model, obtaining a training fusion residual feature by fusing the feature of each image through an attention-based residual feature fusion network of the second model, and obtaining the second high-resolution prediction image based on the training fusion residual feature.

The training may further include obtaining a training optical flow of the training image group, and obtaining a training alignment feature of each image by aligning the feature of each image of the training image group based on the training optical flow.

The obtaining the training fusion residual feature by fusing the feature of each image through the residual feature fusion network may further include obtaining a training fusion weight of each image based on the training alignment feature of each image, and obtaining the training fusion residual feature by assigning a weight to the training alignment feature of each image based on the training fusion weight of each image.

The obtaining the second high-resolution prediction image based on the training fusion residual feature may further include obtaining a training reconstruction feature by reconstructing the training fusion residual feature based on a feature reconstruction network of the second model, and obtaining the second high-resolution prediction image by refining the training reconstruction feature based on a feature refinement network of the second model.

A parameter of the second model may include at least an attention-based residual feature adaptive fusion weight.

The extracting the feature from the training image through the feature extraction network of the initial model may include extracting a feature for the first training sample based on a heterogeneous convolution kernel of a feature extraction network of the first model.

The extracting the feature for each image of the training image group through the feature extraction network of the second model may further include extracting the feature for each image of the training image group based on a heterogeneous convolution kernel of the feature extraction network of the second model.

According to another aspect of an example embodiment, there is provided an electronic device including at least one processor, and at least one memory storing a computer program, wherein the at least one processor is configured to execute the computer program to obtain an input image group, the input image group including a plurality of low-resolution images corresponding to a plurality of different viewpoints, respectively, obtain a feature of low-resolution images by extracting a feature for each low-resolution image of the plurality of low-resolution images included in the input image group, obtain a fusion residual feature by fusing the feature of low-resolution images, and obtain a super-resolution image corresponding to the input image group based on the fusion residual feature.

### BRIEF DESCRIPTION OF THE DRAWINGS

The above and/or other aspects will be more apparent by describing certain example embodiments with reference to the accompanying drawings, in which:

FIG. 1 is a flowchart illustrating a training method of an image processing model according to an embodiment;

FIG. 2 is a diagram illustrating training of an image processing model according to an embodiment;

FIG. 3 is a structural diagram of a single-image super-resolution model according to an embodiment;

FIG. 4 is a structural diagram of a multi-image super-resolution model according to an embodiment;

FIG. 5 illustrates the difference between red, green and blue (RGB) image to RGB image super-resolution and RAW image to RAW image super-resolution;

FIG. 6 is a diagram illustrating super-resolution from a plurality of low-resolution RAW images to a single high-resolution RAW image;

FIG. 7 is an example of a plurality of low-resolution images collected by an array lens camera;

FIG. 8 is a diagram of using attention;

FIG. 9 illustrates a visualization result of channel attention;

FIG. 10 illustrates a visualization result of spatial attention;

FIG. 11 is a flowchart illustrating an image processing method according to an embodiment; and

FIG. 12 is a diagram of an electronic device according to an embodiment.

### DETAILED DESCRIPTION

The following detailed structural or functional description is provided as an example only and various alterations and modifications may be made to embodiments. Thus, an actual form of implementation is not construed as limited to the embodiments described herein and should be understood to include all changes, equivalents, and replacements within the idea and the technical scope of the disclosure.

Although terms, such as “first,” “second,” and the like are used to describe various components, the components are not limited to the terms. These terms should be used only to distinguish one component from another component. For example, a “first component” may be referred to as a “second component,” and similarly the “second component” may also be referred to as the “first component.”

It should be noted that if one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise. It will be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

It will be understood by one of ordinary skill in the art that singular forms “a,” “an,” “the,” and “corresponding” used herein may also include plural forms, unless specifically stated. The terms “comprising” and “containing” used in the embodiments of the present disclosure mean that the corresponding feature may be implemented as the presented feature, information, data, step, operation, element and/or component and do not exclude other features, information, data, steps, operations, elements, components and/or combinations thereof supported by the present technical field. When an element is described to be “connected” or “coupled” to another element, the element may be directly connected or coupled to another element, or a connection relationship between the element and another element may be established through an intermediate element. In addition, “connection” or “coupling” used herein may include wireless connection or wirelessly coupling. In this specification, the term “and/or” represents at least one of the items defined by the term. For example, “A and/or B” represents implementation as “A” or implementation as “A and B.”

Unless otherwise defined, all terms including technical and scientific terms used herein have the same meaning as those commonly understood by one of ordinary skill in the art to which the present disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Artificial intelligence (AI) is a theory, method, technology, and application system to simulate, extend, and expand human intelligence, perceive the environment, obtain knowledge, and use the knowledge to achieve the best result by using a digital computer or a machine controlled by the digital computer. In other words, AI is comprehensive technology of computer science that aims to understand the nature of intelligence and produce a new intelligent machine that can respond similarly to human intelligence. AI is for studying the design principle and implementation method of various intelligent machines so that the machines may have recognition, reasoning, and decision-making functions.

AI technology is a comprehensive field that includes a wide range including both hardware-side technologies and software-side technologies. The basic technologies of AI generally include technologies such as sensors, special AI chips, cloud computing, distributed storage, big data processing technology, operation/interaction systems, electromechanical integration, and the like. AI software technology mainly includes computer vision (CV) technology, voice processing technology, natural language processing technology, machine learning/deep learning, and the like. The present disclosure may relate to CV technology.

CV is the science that studies how machines “see,” and more specifically, uses a camera and a computer instead of human eyes to recognize, track, and measure an object and performs computer processing using additional graphics processing to make an image more suitable for human eyes to observe or for transmission to a detection device. CV is a scientific field that studies related theories and technologies to build an AI system that may obtain information from an image or multi-dimensional data. CV technologies generally include technologies such as image processing, image recognition, semantic understanding of images, image retrieval, optical character recognition (OCR), video processing, semantic understanding of video, video content/action recognition, three-dimensional (3D) object reconstruction, 3D technology, virtual reality (VR), augmented reality (AR), simultaneous positioning, map building, autonomous driving, smart transportation, and the like and may also include common biometric technologies such as face recognition and fingerprint recognition.

For example, the image processing method and apparatus provided by the embodiments may be applied to example scenarios such as AR, image processing, image recognition, object recognition, image segmentation, six-dimension (6D) pose estimation, and the like. For example, an AR scenario generally adds virtual content to a real scenario in front of a user to provide the user with a real scenario experience. In order to implement AR technology-based system processing in a 3D space, high-precision real-time processing and understanding of the 3D state of surrounding objects are required to show high-quality VR fusion effects in front of the user.

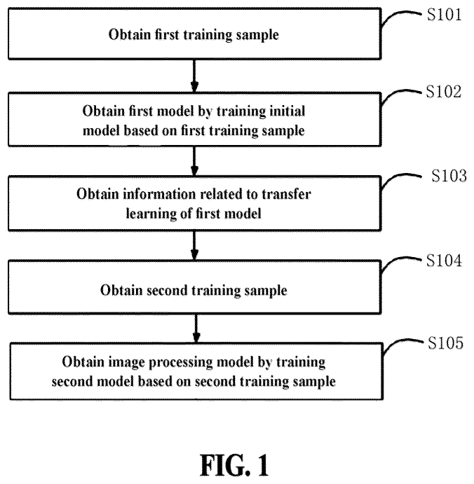

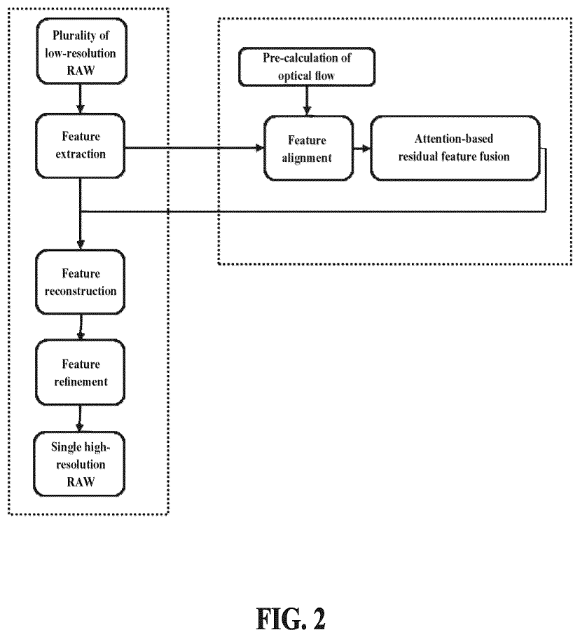

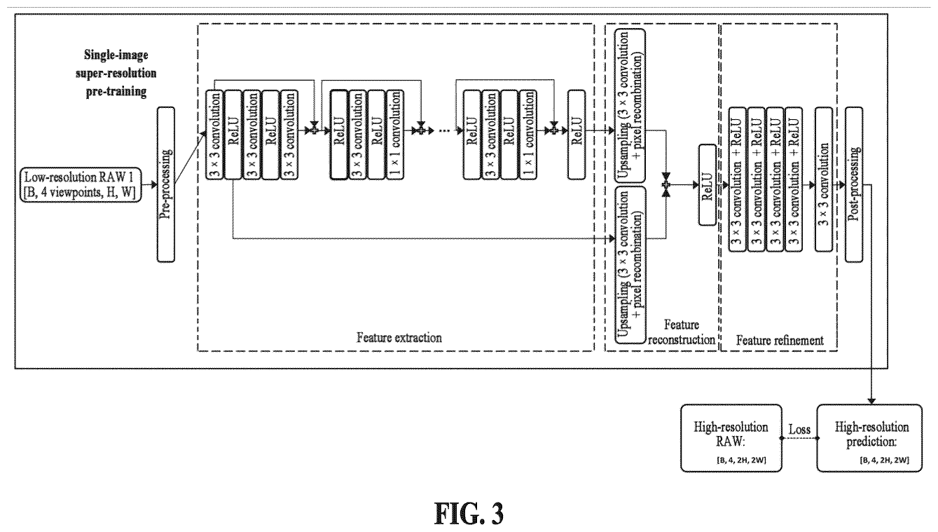

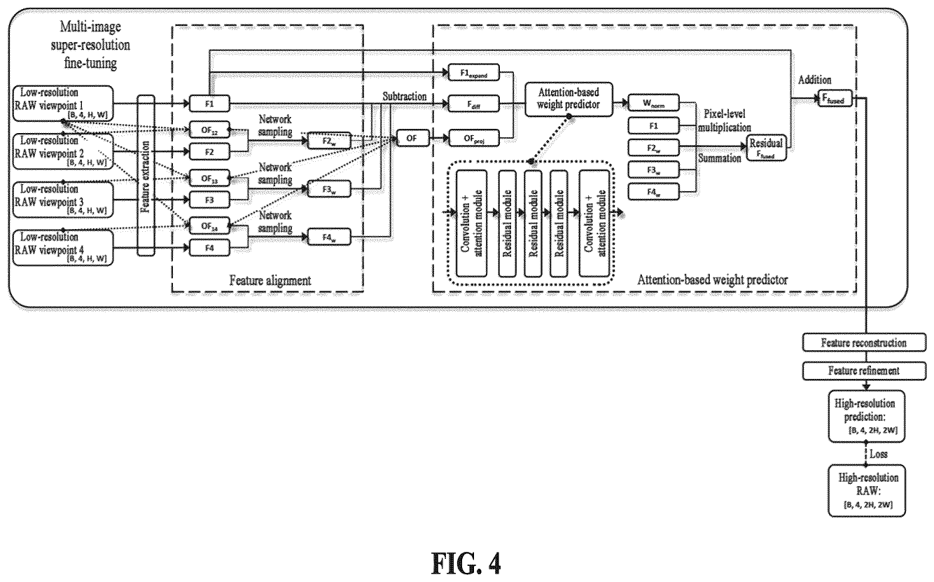

FIG. 1 is a flowchart illustrating a training method of an image processing model according to an embodiment. FIG. 2 is a diagram illustrating training of an image processing model according to an embodiment. FIG. 3 is a structural diagram of a single-image super-resolution model according to an embodiment. FIG. 4 is a structural diagram of a multi-image super-resolution model according to an embodiment.

Referring to FIG. 1, in operation S101, a processor (e.g., a processor 1220 of FIG. 12) may obtain a first training sample. Each first training sample may include a training image and a first training label corresponding to the training image. The training image may include a low-resolution image, and each first training label may represent and correspond to a first high-resolution image of a corresponding training image.

In an embodiment, the training image may be a RAW format image. RAW format may be raw data obtained by converting an optical signal into a digital signal by a camera image processor, that is, image data that has not been further processed after captured by a camera.

In operation S102, the processor may obtain a first model by training an initial model based on the first training sample.

In an embodiment, when obtaining the first model by training the initial model based on the first training sample, the processor may first predict the training image of the first training sample based on the initial model for each first training sample to obtain a first high-resolution prediction image corresponding to the training image. The processor may determine a first prediction loss of the initial model based on the obtained first high-resolution prediction image and the first training label corresponding to the training image and obtain the first model by adjusting a parameter of the initial model based on the first prediction loss. As the first high-resolution prediction image may be a RAW format image, embodiments may be applied to a super-resolution task from a RAW domain to a RAW domain.

In an embodiment, when obtaining the first high-resolution prediction image by inputting the training image to the initial model, the processor may first obtain a feature of the training image by extracting a feature from the training image through a feature extraction network of the initial model and obtain the first high-resolution prediction image based on the feature of the training image.

In an embodiment, when extracting the feature of the training image through the feature extraction network of the initial model, the processor may extract the feature for the first training sample through a heterogeneous convolution kernel of a feature extraction network of the first model and make a network lighter and reduce computing cost through the heterogeneous convolution kernel.

Input of the initial model and the first model may be a single low-resolution image and output of the initial model and the first model may be a single high-resolution image. Hereinafter, the first model is also referred to as a single-image super-resolution model.

As shown in FIG. 2, the single-image super-resolution model may include a feature extraction module (or a feature extraction network), a feature reconstruction module (or a feature reconstruction network), and a feature refinement module (or a feature refinement network) of a heterogeneous convolution kernel, which may operate for RAW data and may maintain a relatively light weight of the model. A trained single-image super-resolution model may obtain a feature representation that is more effective for a super-resolution task.

As shown in FIG. 3, input of the single-image super-resolution model may be a low-resolution RAW image at every viewpoint. The input low-resolution RAW image may be first pre-processed through a pre-processing layer, a feature of the image may be extracted through the feature extraction module, the feature may be reconstructed through the feature reconstruction module, the feature may be refined through the feature refinement module, and the image may be post-processed through a post-processing layer to obtain a high-resolution prediction image corresponding to the input low-resolution RAW image. A loss of the single-image super-resolution model may be determined by comparing the high-resolution prediction image to a high-resolution image (i.e., a training label) corresponding to the low-resolution RAW image.

In an embodiment, the extracted feature may undergo feature alignment and feature fusion of zero optical flow prior to being reconstructed through the feature reconstruction module.

However, embodiments are not limited thereto, and the trained first model or the single-image super-resolution model may be directly obtained without performing operations S101 and S102.

In operation S103, the processor may obtain information related to transfer learning of the first model. The information related to transfer learning of the first model may include a model parameter.

The information related to transfer learning of the first model may be transferred between the single-image super-resolution model and the multi-image super-resolution model.

In operation S104, the processor may obtain a second training sample. Each second training sample may include a training image group and a corresponding second training label. Each second training label may represent a second high-resolution image of a corresponding training image group, and each training image group may include a plurality of low-resolution images corresponding to different viewpoints of the same scene, respectively.

In an embodiment, each training image group may include a plurality of low-resolution images of different viewpoints obtained simultaneously. For example, the plurality of low-resolution images (e.g., RAW format images) of different viewpoints may be obtained simultaneously using an array lens camera.

When different images included in a training image group are obtained in chronological order in a video super-resolution task, the difference in viewpoints between the images may be relatively large when the number of frames is relatively large. In an embodiment, the difference in viewpoints between a plurality of low-resolution images of different viewpoints obtained simultaneously using, for example, an array lens camera may be relatively small. Since optical flow may represent a corresponding relation between images, a more complex optical flow network may be needed to more accurately estimate the corresponding relation between images when the difference in viewpoints between the images is large. For example, additional fine-tuning of the optical flow network in a super-resolution dataset may be needed to achieve a more accurate image alignment. However, embodiments are not limited thereto, and as the difference in viewpoints between images is relatively small, the requirement for complexity of the optical flow network may also be relatively low, and thus, a pre-obtained optical flow may be used. For example, when optical flow data is calculated and obtained in advance using a pre-trained optical flow network and used as an input for model training, the necessary accuracy of image alignment may be achieved, and accordingly, the lightweighting of the entire model may be improved.

In operation S105, the processor may obtain an image processing model by training a second model based on the second training sample. The second model may be configured based on the information related to transfer learning of the first model.

In an embodiment, when obtaining the image processing model by training the second model based on the second training sample, the second model may be first configured based on the information related to transfer learning of the first model, a second high-resolution prediction image may then be obtained by inputting the training image group to the second model, and a second prediction loss of the second model may be determined based on the second high-resolution prediction image and the second training label. Subsequently, the image processing model may be obtained by adjusting a parameter of the second model based on the second prediction loss. As the second high-resolution prediction image may be a RAW format image, embodiments may be applied to performing super-resolution from a RAW domain to a RAW domain.

Performing super-resolution from a RAW domain to a red, green and blue (RGB) domain and from an RGB domain to an RGB domain may have a relatively low super-resolution result due to a portion of original information being lost due to the RGB domain. Embodiments may be applied to a super-resolution task from a RAW domain to a RAW domain and may thus improve the super-resolution effect.

In an embodiment, when obtaining the second high-resolution prediction image by inputting the training image group to the second model, a feature of each image may be first obtained by extracting a feature for each image of the training image group through a feature extraction network of the second model, and a training fusion residual feature may be obtained by fusing the feature of each image through an attention-based residual feature fusion network of the second model. The second high-resolution prediction image may then be obtained based on the training fusion residual feature.

In an embodiment, a training optical flow of the training image group may be first obtained, and a training alignment feature of each image may be obtained by aligning the feature of each image of the training image group based on the training optical flow. Here, the training optical flow may be a pre-calculated (pre-obtained) optical flow. The prior calculation may be performed using any optical flow calculation method, but embodiments are not limited thereto.

As the optical flow may represent the corresponding relation between images, when the difference in viewpoints between the images included in the training image group is relatively large, a more complex optical flow model may need to be used to solve an image alignment issue. For example, to achieve a more accurate image alignment, additional fine-tuning of the optical flow network in a super-resolution dataset may be needed, which may make the overall structure and design of the network for super-resolution more complex and consequently result in a relatively larger model, which may not be distributed to mobile platforms. However, embodiments are not limited thereto, and as the difference in viewpoints between images of different viewpoints is relatively small and the requirement for complexity of the optical flow network is also relatively low, a pre-calculated (pre-obtained) optical flow may be used. For example, since optical flow data may be calculated and obtained in advance using a pre-trained optical flow network and used as an input for model training, that is, the necessary accuracy of image alignment may be achieved, the lightweighting of the entire model may be improved.

In an embodiment, when obtaining the training fusion residual feature by fusing the feature of each image through the attention-based residual feature fusion network of the training model, a training fusion weight of each image may be first determined based on the training alignment feature of each image, and the training fusion residual feature may be obtained by calculating and obtaining a weight for the training alignment feature according to the training fusion weight of each image.

In an embodiment, when obtaining the second high-resolution prediction image based on the training fusion residual feature, a training reconstruction feature may be first obtained by reconstructing the training fusion residual feature through a feature reconstruction network of the second model. The second high-resolution prediction image may then be obtained by refining the training reconstruction feature through a feature refinement network of the second model.

In an embodiment, a parameter of the second super-resolution model may include at least an attention-based residual feature adaptive fusion weight. In addition, a parameter of the multi-image super-resolution model may also include a parameter related to the information related to transfer learning. In addition, the multi-image super-resolution model may also include another parameter, and the type of parameter according to embodiments is not limited thereto.

In an embodiment, when extracting the feature for each image of the training image group through the feature extraction network of the second model, the feature of each image of the training image group may be extracted through a heterogeneous convolution kernel of the feature extraction network of the second model. The network may be lightweighted and the computing cost may be reduced through the heterogeneous convolution kernel.

In related embodiment, when an optical network is integrated into a super-resolution network, the overall structure and design of the network of super-resolution may become relatively complex and the model may become larger, making it more difficult to distribute the model to mobile platforms. In an embodiment, since a pre-calculated (pre-obtained) optical flow may be used to align the feature without the need for an optical flow network, the calculation cost and the model size may be reduced and the model may more easily be deployed in mobile platforms.

Input of the second model and the image processing model may be a plurality of low-resolution images and output of the second model and the image processing model may be a single high-resolution image. Hereinafter, the second model is also referred to as a multi-image super-resolution model.

As shown in FIG. 2, the multi-image super-resolution model may use a feature alignment module (or a feature alignment network) to align features of images of different viewpoints in a feature embedding space, using a pre-calculated (pre-obtained) optical flow, learn an attention-based residual feature adaptive fusion weight using an attention-based residual feature fusion module (or an attention-based residual feature fusion network), and through this, more effectively utilize the plurality of low-resolution inputs to ultimately restore an accurate high-resolution RAW image.

As shown in FIG. 4, input of the multi-image super-resolution model may be a plurality of low-resolution RAW images of different viewpoints. A feature of the input low-resolution RAW images of different viewpoints may be extracted through the feature extraction module, aligned through the feature alignment module, fused through the attention-based residual feature fusion module, reconstructed through the feature reconstruction module, and refined through the feature refinement module. Through this process, a high-resolution prediction image corresponding to the input low-resolution RAW images of different viewpoints may be obtained. A loss of the multi-image super-resolution model may be determined by comparing the high-resolution predicted image to a high-resolution image corresponding to the input low-resolution RAW images of different viewpoints.

The transfer learning may accelerate the training of the entire network model and improve performance.

The multi-image super-resolution model (or a multi-image super-resolution fine-tuning network) may, when the optical flow and the learned residual are both zero, degenerate to the single-image super-resolution model (or a single-image super-resolution pre-training network). A single-image super-resolution pre-training process of the single-image super-resolution model of the first step may obtain a more effective feature representation for a super-resolution task, thus providing good weight initialization to the multi-image super-resolution model. The pre-training process of the single-image super-resolution model and a fine-tuning training process of the multi-image super-resolution model may accelerate the training of the entire network and help achieve better performance.

In the pre-training process of the single-image super-resolution model, RAW image to RAW image super-resolution prediction may be performed. An RGB image may be obtained from a RAW image through a series of image signal processing processes such as demosaicing, automatic white balance, and the like. Conversion from a RAW image to an RGB image may entail a loss, and RAW data may contain more information than RGB data and may have higher accuracy and bit number.

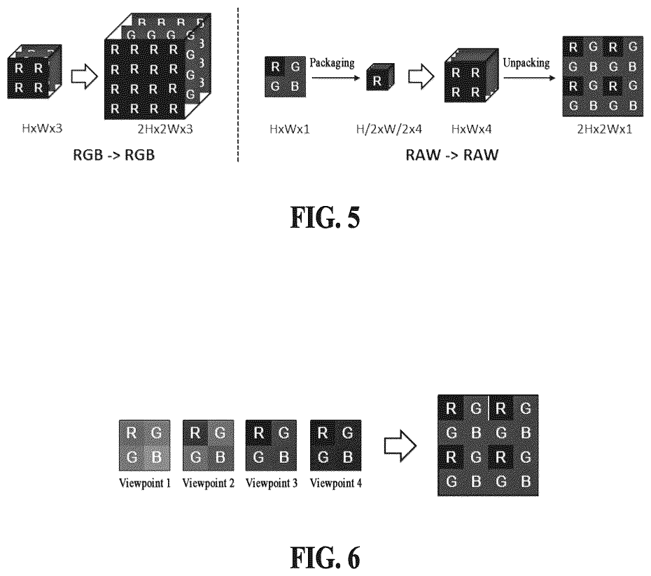

FIG. 5 illustrates the difference between RGB image to RGB image super-resolution and RAW image to RAW image super-resolution. As shown in FIG. 5, in the RAW image to RAW image super-resolution, a 2×2 pixel array (RGGB) may be a basic unit of a RAW image in Bayer mode. In a super-resolution task from a RAW image to a RAW image, packaging and unpacking processes may be added. The RAW image in Bayer mode of one channel may be first packaged into four channels for super-resolution processing, and an obtained super-resolution image of the four channels may be unpacked into the RAW image in Bayer mode. Compared to the RGB image to RGB image super-resolution, three channels of the RGB image may be completely aligned at the input and output, whereas there is a pixel deviation between the four channels of the RAW image. Due to the translation equivariance characteristic of a convolutional operation, the entire convolutional network may be used to process the operation, thereby improving the lightweighting effect.

For example, the feature extraction module may include at least one 3×3 convolutional layer and at least one 1×1 convolutional layer and be configured with the 3×3 convolutional layer and the 1×1 convolutional layer intersecting. The feature extraction module may reduce the number of parameters while maintaining performance so that the lightweight of the network may be maintained. The feature reconstruction module may include an upsampling layer, which includes a 3×3 convolutional layer and pixel recombination, and residual learning. The feature refinement module may include a 3×3 convolutional layer. A more effective feature representation for a super-resolution task may be obtained through lightweight network design. The result of a sample data set (e.g., an array lens camera data set) that used a single-image super-resolution pre-training network is shown in the second column of Table 1, with a peak signal-to-noise ratio (PSNR) of 37.3926 and a structural similarity (SSIM) of 0.9594.

TABLE 1

| | | Lightweight multi- | Lightweight multi- |
|---|---|---|---|
| | | image super- | image super- |
| | | resolution, residual | resolution, residual |
| | Lightweight single- | feature fusion | feature fusion |
| | image super- | used, attention not | used, attention |
| | resolution | used | used |
| PSNR | 37.3926 | 38.3079 | 38.4949 |
| SSIM | 0.9594 | 0.9652 | 0.9654 |

A task performed in a multi-image super-resolution fine-tuning step may be a super-resolution task from a plurality of low-resolution RAW images to a single high-resolution RAW image.

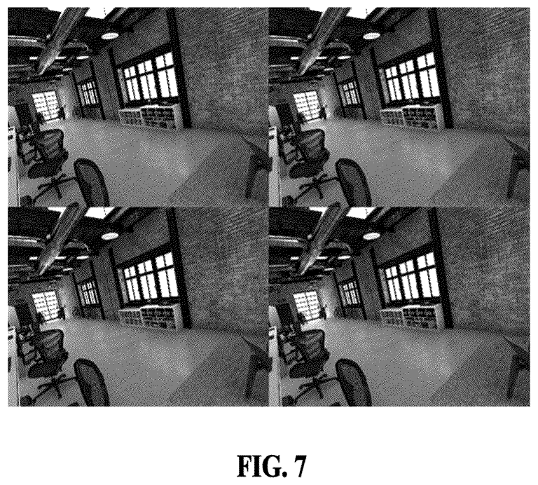

FIG. 6 is a diagram illustrating super-resolution from a plurality of low-resolution RAW images to a single high-resolution RAW image. FIG. 7 is an example of a plurality of low-resolution images obtained by an array lens camera. For example, FIG. 6 illustrates super-resolution from four low-resolution RAW images to a single high-resolution RAW image. In the multi-image super-resolution fine-tuning step, the feature of images of various viewpoints may be first aligned in a feature embedding space, using a pre-calculated (pre-obtained offline optical flow. The array lens camera may include a 2×2 lens array, and due to the design, low-resolution RAW images of different viewpoints may be obtained simultaneously, and the difference in viewpoints between the images may be relatively small as shown in FIG. 7. For example, the low-resolution RAW image of viewpoint 1 may be taken as a reference image, and the alignment to be processed may be to align a low-resolution RAW image of a different viewpoint with the low-resolution RAW image of viewpoint 1. Here, an image of which viewpoint will be used as a reference image may be determined based on the parameters of the array lens camera. For example, the order of viewpoints of a plurality of low-resolution images of different viewpoints may be determined according to the parameters of the array lens camera, and a reference image may be determined according to the order of viewpoints. For example, a low-resolution image of a first viewpoint may be used as a reference image. As the change in viewpoints is relatively small, an image alignment issue may be solved by directly using an optical flow calculated and obtained offline. Calculating and obtaining the optical flow part may not be included in the training process, which may help reduce the calculation cost and maintain the lightweighting of the model.

By proposing an attention-based residual feature fusion module, a plurality of low-resolution inputs may be more effectively utilized, an attention-based adaptive fusion weight may be learned, and residual feature learning may be performed. The residual feature learning may help solve a long-term dependency issue, and an adaptive weight may allow a network to be trained using any number of images. The result of a sample data set of a multi-image super-resolution network that used residual feature fusion is shown in the third column of Table 1, with a PSNR of 38.3079 and a SSIM of 0.9652.

In the multi-image super-resolution task, the network may converge faster through residual learning. When performing the residual learning, the correlation between different positions and channels in an image and the importance of the super-resolution task may also need to be considered. For example, an edge area and a smooth area may have different importance in the residual feature learning. The edge area may be relatively more important.

In order to better model the correlation between different channels and different spatial positions to improve more important features during residual learning, an attention mechanism may be added to an image processing model (e.g., an attention parameter may be added to the image processing model).

For example, attention may include channel attention and spatial attention. The correlation between different positions and channels in an image may be considered through attention-based residual feature adaptive fusion weight learning, and through this, a plurality of low-resolution inputs may be more effectively used.

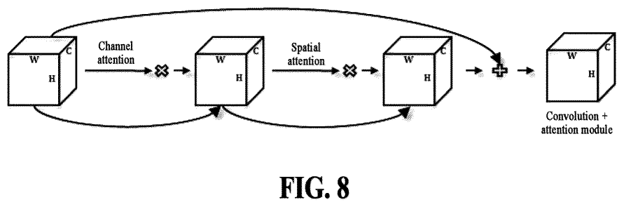

FIG. 8 is a diagram of using attention. As shown in FIG. 8, attention may include channel attention and spatial attention consecutively. For example, for channel attention, a weight may be learned based on each channel and processed along the channel axis in a feature map. For spatial attention, a weight may be learned based on each spatial position and processed along the spatial coordinates in the feature map. For example, local residual learning may also be performed during residual learning. In this case, the use of attention may be as shown in Equation 1 below.

Rⱼ=Rⱼ₋₁+M_{J}^{SA}⊗(M_{J}^{CA}⊗Rⱼ₋₁) [Equation 1]

Here, M_{J}^{CA} and M_{J}^{CA} respectively denote channel attention and spatial attention, and Rⱼ₋₁ and Rⱼ respectively denote feature maps of the j−1-th layer and the j-th layer. Using attention may help model the correlation between different positions in a channel dimension and spatial coordinates and may improve more important features during residual learning. After adding attention, the result of the multi-image super-resolution network for the sample data set is further improved, with a PSNR of 38.4949 and a SSIM of 0.9654.

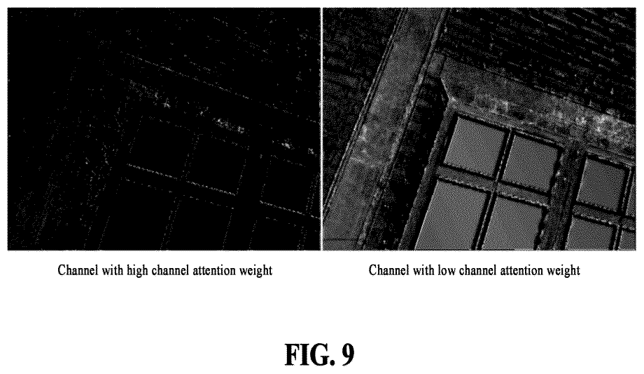

FIG. 9 illustrates a visualization result of channel attention. FIG. 9 shows feature maps corresponding to when a channel attention weight is large (high) and small (low). As shown in FIG. 9, when learning residual features, a feature map including more edges and details may be assigned a larger weight, while a feature map including a smoother texture may be assigned a lower weight.

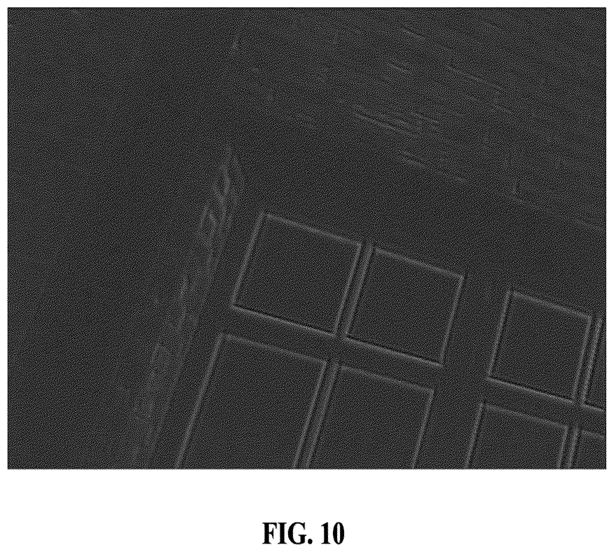

FIG. 10 illustrates a visualization result of spatial attention. As found in FIG. 10, when learning residual features, a feature map including more edges and details may be assigned a larger weight, while a feature map including a smoother texture may be assigned a lower weight.

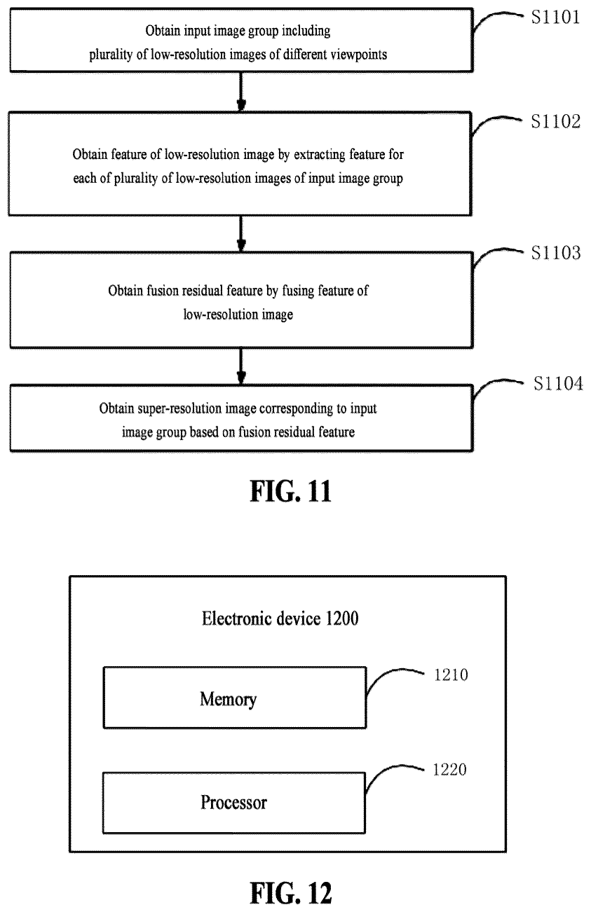

FIG. 11 is a flowchart illustrating an image processing method according to an embodiment.

Referring to FIG. 11, in operation S1101, a processor (e.g., the processor 1220 of FIG. 12) may obtain an input image group, and the input image group may include a plurality of low-resolution images of different viewpoints.

For example, the processor may use an array lens camera to obtain a plurality of low-resolution images of different viewpoints. For example, FIGS. 6 and 7 may be referred to.

For example, the processor may collect the plurality of low-resolution images of different viewpoints simultaneously.

In an embodiment, the plurality of low-resolution images of different viewpoints included in the input image group may be a plurality of RAW format images of different viewpoints obtained simultaneously.

In a video super-resolution task, as different images included in the input image group may be obtained in chronological order, the difference in viewpoints between the images may be relatively large when the number of frames is relatively large. However, embodiments are not limited thereto, and the difference in viewpoints between a plurality of low-resolution images of different viewpoints obtained simultaneously using, for example, an array lens camera may be relatively small.

In operation S1102, the processor may obtain a feature of each low-resolution image by extracting a feature for each of the plurality of low-resolution images of the input image group through a feature extraction network of an image processing model.

For example, a parameter of the image processing model may include at least an attention-based residual feature adaptive fusion weight. In addition, the parameter of the image processing model may include a parameter related to information related to transfer learning. In addition, the image processing model may also include another parameter, and the type of parameter according to embodiments is not limited thereto.

In an embodiment, the processor may obtain an alignment feature of each low-resolution image by aligning the feature of each low-resolution image through a feature alignment network of the image processing model, thereby facilitating feature fusion.

For example, the processor may use an image of a first viewpoint of each low-resolution image as a reference image and may align features of an image of a different viewpoint of each low-resolution image and the image of the first viewpoint that is a reference image. The image of the first viewpoint of each low-resolution image may be determined according to the parameters of the array lens camera. For example, the order of viewpoints of a plurality of low-resolution images of different viewpoints may be determined according to the parameters of the array lens camera, and a reference image may be determined according to the order of viewpoints. For example, a low-resolution image of a first viewpoint may be used as a reference image.

In an embodiment, when aligning the feature of each low-resolution image through the feature alignment network of the image processing model, an optical flow of the input image group may be first obtained and the feature of each image may then be aligned based on the optical flow. In an embodiment, the optical flow may be a pre-calculated (pre-obtained) optical flow or a pre-calculated (pre-obtained) pixel-level optical flow. The calculation may be performed using any optical flow calculation method, but the present disclosure is not limited to this method. In an embodiment, as a pre-calculated (pre-obtained) optical flow may be used to align the feature without the need for an optical flow network, the calculation cost and the model size may be reduced and the model may more easily be deployed in mobile platforms.

In an embodiment, when extracting a feature for low-resolution images of an input image group through a feature extraction network of an image processing model, a feature for each of the low-resolution images of the input image group may be extracted through a heterogeneous convolution kernel of the feature extraction network of the image processing model. The network may be lightweighted and the computing cost may be reduced through the heterogeneous convolution kernel.

When the difference in viewpoints between the images included in the input image group is large, a more complex optical flow model may need to be used to solve an image alignment issue. To achieve a more accurate image alignment, the optical flow network may need to be additionally fine-tuned in a super-resolution data process. In an embodiment, for example, an array lens camera may be used to collect images of different viewpoints and as a result, the difference in viewpoints between images of different viewpoints may be smaller and the requirement for complexity of the optical flow network may also be lowered. Optical flow data may be pre-calculated (pre-obtained) using the pre-calculated (pre-obtained) optical flow, for example, using a pre-trained optical flow network, and the optical flow data may be used as input to the image processing model along with the input image group. Accordingly, the necessary accuracy of image alignment may be achieved.

In operation S1103, a fusion residual feature may be obtained by fusing the feature of each low-resolution image through an attention-based residual feature fusion network of the image processing model.

In an embodiment, when obtaining the fusion residual feature by fusing the feature of each low-resolution image through the attention-based residual feature fusion network of the image processing model, the fusion residual feature may be obtained by fusing the alignment feature of each low-resolution image through the attention-based residual feature fusion network of the image processing model.

In an embodiment, when obtaining the fusion residual feature by fusing the alignment feature of each low-resolution image through the attention-based residual feature fusion network of the image processing model, a fusion weight of each low-resolution image may be first determined based on the alignment feature of each low-resolution image, and the fusion residual feature may be obtained by calculating and obtaining a weight for the alignment feature according to the fusion weight of each low-resolution image.

Through an attention-based residual feature fusion module, a plurality of low-resolution inputs may be more effectively utilized, an attention-based adaptive fusion weight may be learned, and residual feature learning may be performed. In particular, residual feature learning may help solve a long-term dependency issue. Through an attention mechanism, the correlation between different channels and spatial positions may be better modeled, and more important features during residual learning may be improved. The correlation between different positions and channels in an image may be considered through attention-based residual feature adaptive fusion weight learning, and through this, a plurality of low-resolution inputs may be more effectively used. Attention may include channel attention and spatial attention. Attention may include channel attention and spatial attention consecutively. Specifically, for channel attention, a weight may be learned based on each channel and processed along the channel axis in a feature map. For spatial attention, a weight may be learned based on each spatial position and processed along the spatial coordinates in the feature map. For example, local residual learning may be performed during residual learning.

In operation S1104, the super-resolution image corresponding to the input image group may be obtained based on the fusion residual feature.

In an embodiment, when obtaining a super-resolution image corresponding to the input image group based on the fusion residual feature, a reconstruction feature may be first obtained by reconstructing the fusion residual feature through a feature reconstruction network of the image processing model. The super-resolution image corresponding to the input image group may then be obtained by refining the reconstruction feature through a feature refinement network of the image processing model.

In an embodiment, since the super-resolution image corresponding to the input image group may be a RAW format image, the present disclosure may be applied to a super-resolution task from a RAW domain to a RAW domain.

Performing super-resolution from a RAW domain to an RGB domain and from an RGB domain to an RGB domain may have a poor super-resolution result since a portion of original information may be lost due to the RGB domain. However, embodiments may be applied to a super-resolution task from a RAW domain to a RAW domain and may thus improve the super-resolution effect.

By using the image processing model trained according to the training method of an image processing model of the present disclosure, information of images of various viewpoints may be combined, richer details may be reconstructed, more textures and sharper edges may be restored, and accordingly, an accurate high-resolution image may be restored.

In addition, with a lightweight network design and architecture based on a heterogeneous convolutional kernel (which does not require an optical flow network), the image processing model may be distributed to mobile platforms. Through attention-based residual feature fusion, the correlation between different positions and channels in an image may be considered and information of a plurality of images may be effectively used. The image processing model may utilize a pre-training and fine-tuning training processes to accelerate network training and achieve better performance.

The image processing method and the training method of an image processing model according to an embodiment are described above with reference to FIGS. 1 to 11. Hereinafter, an electronic device according to an embodiment is described with reference to FIG. 12.

FIG. 12 is a diagram of an electronic device according to an embodiment.

Referring to FIG. 12, an electronic device 1200 may include at least one memory 1210 and at least one processor 1220, wherein the memory 1210 may store computer-executable instructions. The computer-executable instructions may, when executed by the processor 1220, cause the processor 1220 to execute the image processing method and the training method of an image processing model according to an embodiment.

At least one module among the plurality of modules (or networks) may be implemented through an AI model. AI-related functions may be performed by a non-volatile memory, a volatile memory, and a processor.

The processor 1220 may include one or more processors. Here, the one or more processors may be, for example, a general-purpose processor (e.g., a central processing unit (CPU), an application processor (AP), etc.) or a graphics-dedicated processing unit (e.g., a graphics processing unit (GPU), a vision processing unit (VPU)) and/or an AI-dedicated processor (e.g., a neural processing unit (NPU)).

The one or more processors may control processing of input data according to the AI model or a predefined operation rule stored in the non-volatile memory and the volatile memory. The predefined operation rule or the AI model may be provided through training or learning.

Here, providing the predefined operation rule or the AI model through learning may indicate obtaining a predefined operation rule or an AI model having desired characteristics by applying a learning algorithm to a plurality of pieces of training data. The training may be performed by an apparatus itself in which AI is performed according to an embodiment or by a separate server/apparatus/system.

The learning algorithm may be a method of causing, allowing, or controlling a predetermined target apparatus (e.g., a robot) to perform determination or prediction by training the target apparatus using the plurality of pieces of training data. The learning algorithm may include, for example, supervised learning, unsupervised learning, semi-supervised learning, or reinforcement learning. However, embodiments are not limited thereto.

The AI model may be obtained through training. Here, “being obtained through training” may refer to obtaining the predefined operation rule or the AI model configured to perform a desired feature (or objective) by training a basic AI model with multiple pieces of training data through a training algorithm.

The AI model may include, for example, a plurality of neural network layers. Each layer may have a plurality of weights, and calculation of one layer may be performed based on a calculation result of a previous layer and the plurality of weights of the current layer. A neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q network, but is not limited thereto.

The electronic device 1200 may be, for example, a personal computer (PC), a tablet device, a personal digital assistant (PDA), a smartphone, or other devices capable of executing a set of instructions stated above. Here, the electronic device may not need to be a single electronic device and may be an assembly of apparatuses or circuits capable of executing the instructions (or the set of instructions) alone or jointly. The electronic device may also be a part of an integrated control system or a system administrator or may be configured as a portable electronic device that interfaces locally or remotely (e.g., via wireless transmission).

In the electronic device, the processor may include a CPU, a GPU, a programmable logic device, a dedicated processor system, a microcontroller, or a microprocessor. In addition, the processor may include, for example, an analog processor, a digital processor, a microprocessor, a multicore processor, a processor array, or a network processor. However, embodiments are not limited thereto.

The processor may execute instructions or code stored in the memory, which may further store data. Instructions and data may also be transmitted and received over a network via a network interface that may use a known transport protocol.

While example embodiments have been described with reference to the figures, it will be understood by those of ordinary skill in the art that various changes in form and details may be made therein without departing from the spirit and scope as defined by the following claims and their equivalents.

What is claimed is:

1. An image processing method of an image processing model, the image processing method comprising:
obtaining an input image group comprising a plurality of low-resolution images corresponding to a plurality of different viewpoints;
obtaining a feature of low-resolution images by extracting a feature for each low-resolution image of the plurality of low-resolution images of the input image group;
obtaining a fusion residual feature by fusing the feature of the low-resolution images; and
obtaining, based on the fusion residual feature, a super-resolution image corresponding to the input image group.

2. The image processing method of claim 1, wherein the obtaining the fusion residual feature by fusing the feature of the low-resolution images comprises:
obtaining an alignment feature of the low-resolution images by aligning the feature of the low-resolution images; and
obtaining the fusion residual feature by fusing the alignment feature of low-resolution images through an attention-based residual feature fusion network of the image processing model.

3. The image processing method of claim 2, wherein the obtaining the fusion residual feature by fusing the alignment feature of the low-resolution images comprises:
obtaining a fusion weight of each low-resolution image of the plurality of low-resolution images based on the alignment feature of the low-resolution images; and
obtaining the fusion residual feature by obtaining a weight for the alignment feature of low-resolution images based on the fusion weight of the low-resolution images.

4. The image processing method of claim 2, wherein the obtaining the alignment feature of the low-resolution images by aligning the feature of the low-resolution images comprises:
obtaining an optical flow of the input image group; and
obtaining the alignment feature of the low-resolution images by aligning the feature of the low-resolution images based on the optical flow.

5. The image processing method of claim 4, wherein the optical flow is a pre-obtained optical flow.

6. The image processing method of claim 1, wherein the extracting the feature for each of the plurality of low-resolution images of the input image group comprises:
extracting a feature for each low-resolution image of the plurality of low-resolution images of the input image group through a heterogeneous convolution kernel of a feature extraction network of the image processing model.

7. The image processing method of claim 1, wherein the plurality of low-resolution images corresponding to the plurality of different viewpoints of the input image group are a plurality of raw format images corresponding to a plurality of different viewpoints obtained simultaneously.

8. The image processing method of claim 1, wherein the obtaining the super-resolution image corresponding to the input image group based on the fusion residual feature comprises:
obtaining a reconstruction feature by reconstructing the fusion residual feature a feature reconstruction network of the image processing model; and
obtaining the super-resolution image corresponding to the input image group by refining the reconstruction feature through a feature refinement network of the image processing model.

9. A training method of an image processing model, the training method comprising:
obtaining a first training sample, wherein the first training sample comprises a training image and a first training label corresponding to the training image, the training image comprises a low-resolution image and the first training label corresponds to a first high-resolution image of a corresponding training image;
obtaining a first model by training an initial model based on the first training sample;
obtaining information corresponding to transfer learning of the first model;
obtaining a second training sample comprising a training image group and a second training label corresponding to the training image group, the training image group comprising a plurality of low-resolution images corresponding to a plurality of different viewpoints of a same scene, and the second training label corresponding to a second high-resolution image of a corresponding training image group; and
obtaining an image processing model by training a second model based on the second training sample, wherein the second model is configured based on the information corresponding to transfer learning of the first model.

10. The training method of claim 9, wherein the obtaining the first model by training the initial model based on the first training sample comprises:
obtaining a first high-resolution prediction image by inputting the training image to the initial model;
obtaining a first prediction loss of the initial model based on the first high-resolution prediction image and the first training label; and
obtaining the first model by adjusting a parameter of the initial model based on the first prediction loss.

11. The training method of claim 10, wherein the obtaining the first high-resolution prediction image by inputting the training image to the initial model comprises:
obtaining a feature of the training image by extracting a feature from the training image through a feature extraction network of the initial model; and
obtaining the first high-resolution prediction image based on the feature of the training image.

12. The training method of claim 11, wherein the obtaining the image processing model by training the second model based on the second training sample further comprises:
obtaining a second high-resolution prediction image by inputting the training image group to the second model;
obtaining a second prediction loss of the second model based on the second high-resolution prediction image and the second training label; and
obtaining the image processing model by adjusting a parameter of the second model based on the second prediction loss.

13. The training method of claim 12, wherein the obtaining the second high-resolution prediction image by inputting the training image group to the second model comprises:
obtaining a feature of each image by extracting a feature for each image of the training image group through a feature extraction network of the second model;
obtaining a training fusion residual feature by fusing the feature of each image through an attention-based residual feature fusion network of the second model; and
obtaining the second high-resolution prediction image based on the training fusion residual feature.

14. The training method of claim 13, further comprising:
obtaining a training optical flow of the training image group; and
obtaining a training alignment feature of each image by aligning the feature of each image of the training image group based on the training optical flow.

15. The training method of claim 14, wherein the obtaining the training fusion residual feature by fusing the feature of each image through the residual feature fusion network comprises:
obtaining a training fusion weight of each image based on the training alignment feature of each image; and
obtaining the training fusion residual feature by assigning a weight to the training alignment feature of each image based on the training fusion weight of each image.

16. The training method of claim 13, wherein the obtaining the second high-resolution prediction image based on the training fusion residual feature comprises:
obtaining a training reconstruction feature by reconstructing the training fusion residual feature through a feature reconstruction network of the second model; and
obtaining the second high-resolution prediction image by refining the training reconstruction feature through a feature refinement network of the second model.

17. The training method of claim 9, wherein a parameter of the second model comprises at least an attention-based residual feature adaptive fusion weight.

18. The training method of claim 11, wherein the extracting the feature from the training image through the feature extraction network of the initial model comprises:
extracting a feature for the first training sample through a heterogeneous convolution kernel of a feature extraction network of the first model.

19. The training method of claim 13, wherein the extracting the feature for each image of the training image group through the feature extraction network of the second model comprises:
extracting the feature for each image of the training image group based on a heterogeneous convolution kernel of the feature extraction network of the second model.

20. An electronic device comprising:
at least one processor; and
at least one memory storing a computer program,
wherein the at least one processor is configured to execute the computer program to:
obtain an input image group, the input image group comprising a plurality of low-resolution images corresponding to a plurality of different viewpoints;
obtain a feature of low-resolution images by extracting a feature for each low-resolution image of the plurality of low-resolution images of the input image group;
obtain a fusion residual feature by fusing the feature of low-resolution images; and
obtain a super-resolution image corresponding to the input image group based on the fusion residual feature.
